(19) United States
(12) Patent Application Publication
(10) Pub. No.: US 2012/0072544 A1
(43) Pub. Date: Mar. 22, 2012

(54) ESTIMATING APPLICATION PERFORMANCE IN A NETWORKED ENVIRONMENT

(75) Inventor: Alexandre Pankratov, Burnaby (CA)

(73) Assignee: PRECISION NETWORKING, INC., Vancouver (CA)

(21) Appl. No.: 13/153,770

(22) Filed: Jun. 6, 2011

(51) Int. Cl. G06F 15/16

(52) U.S. Cl. 709/219

(57) ABSTRACT

Systems and methods for estimating application performance are provided. According to one embodiment, one or more tests involving an application exchange are performed by one or more computer systems at a control location with an application provided by a target location not in proximity to the control location. A control-target path profile is determined by performing one or more network tests over a network path between the control location and the target location. A test-target path profile is determined by performing one or more network tests. A target profile is generated based on results of the one or more tests involving the application exchange with the application and the control-target path profile. Finally, an estimate of one or more performance metrics of an application exchange with the application between a test location and the target location is provided based on the test-target path profile and the target profile.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2011, Precision Networking, Inc.

### BACKGROUND

2. Field

Embodiments of the present invention generally relate to the field of application performance measurement in a networked environment. In particular, various embodiments relate to methods of estimating the performance of higher-level application protocols using measurements with respect to simpler protocols and multiple observation points (e.g., a control network node and a client network node).

2. Description of the Related Art

Network-based (e.g., Internet-based) applications have seen growing adoption and deployment rates in recent years and this has given rise to the need for accurate measurement of client-side experience. From traditional web to emerging cloud-based applications, knowing how fast the application feels at the user's end is frequently an essential metric in evaluating the quality of the application and the associated user experience.

Typical solutions for measuring network performance of such applications involve deploying dedicated test agents in proximity with a target user location and then measuring the performance with test scripts that emulate desired user interactions. Alternatively, the agents may be deployed on the actual user's computers to passively record the performance information when the user is using the application.

In either case, according to existing methodologies, the performance of an application at a specific location is measured by looking at data relating to actual application traffic. For example, to measure the loading speed of a web page at certain location, a test agent is used to access the web page using the HyperText Transport Protocol (HTTP), from a location in proximity to the specific location.

### SUMMARY

Systems and methods are described for estimating application performance. According to one embodiment, one or more tests involving an application exchange are performed by one or more computer systems at a control location with an application provided by a target location not in proximity to the control location. A control-target path profile is determined by performing a first set of one or more network tests over a network path between the control location and the target location. A test-target path profile is determined by performing a second set of one or more network tests. A target profile is generated based on results of the one or more tests involving the application exchange with the application and the control-target path profile. Finally, an estimate of one or more performance metrics of an application exchange with the application between a test location and the target location is provided based on the test-target path profile and the target profile.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating a simplified network environment in which embodiments of the present invention may be employed.

FIG. 2 is a block diagram conceptually illustrating interaction among various functional units of a control location in accordance with an embodiment of the present invention.

FIG. 3 is a high-level flow diagram illustrating application performance estimation processing in accordance with an embodiment of the present invention.

FIG. 4 is a flow diagram illustrating performance metric estimation processing in accordance with an embodiment of the present invention.

FIG. 5 is a flow diagram illustrating performance metric estimation processing in accordance with an alternative embodiment of the present invention.

FIG. 6 is an example of a computer system with which embodiments of the present invention may be utilized.

### DETAILED DESCRIPTION

Systems and methods are described for estimating application performance at a first location based on (i) application performance measurements taken at a second location not in proximity to the first location and (ii) network metrics associated with both locations. According to one embodiment, application performance measurements relating to a network-based application provided by a target location are made by a control location not in proximity to the location (e.g., a test location) at which the application performance estimate pertains. Network metrics associated with both the control location and the test location are also gathered. Then, an estimate of the application performance as expected to be experienced at the test location can be generated based on the application performance measurements taken at the control location and the gathered network metrics pertaining to the paths between the control location and the target location and the test location and the target location. Advantageously, in this manner, cost effective and reliable estimates of application performance may be obtained, without use or measurement of actual application traffic between the test location and the target location, by way of one or more agents within or in close proximity to the test location, for example.

According to one embodiment, the estimation process involves creation of a model of the application exchange and this model is then evaluated for test-target network conditions. For example, a model may be created based on the observed control-target application exchange. Then, various network parameters measured in relation to the test-target path may be run through the model to produce a performance metric for the test location.

According to another embodiment, the estimation process involves simulation. The target's responses may be captured by the control location by running a first application test. Then, one or more estimated performance metrics can be produced on the basis of a second application test run against a simulated target system (e.g., which simply replays the previously captured responses) and in which measured test-target path conditions are simulated.

While, for convenience and sake of brevity, various embodiments of the invention are discussed in the context of the performance metric at issue being the speed of the exchange, speed of application exchange is simply one example of various metrics that can be estimated. Embodiments of the present invention are not so limited and are equally applicable to estimation and/or measurement of other performance metrics that will be apparent to those of ordinary skill in the art. For example, in the context of profiling a media streaming application, one may be more interested in measuring/estimating other indications of “performance,” such as sustained frame rate or encoding quality. As such, the examples provided herein relating to speed of application exchange should not be interpreted as limiting the numerous alternative performance metrics contemplated.

Additionally, for ease of demonstration, various embodiments and/or concrete examples are described with reference to estimating the loading time of a web page; however, it is to be understood, that the application performance estimation methodologies described herein are equally applicable to application and/or network protocols other than HTTP, including, but not limited to FTP, POP3, SMTP, IMAP, SNMP, SSH and SSL/TLS. Therefore, the specific examples presented herein are not intended to be limiting and are merely representative of exemplary functionality.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrase “control location” generally refers to a location that is managed by or on behalf of a person or entity driving an application exchange performance measurement/estimation process. This entity or person may be the same or different person or entity that is offering or otherwise making available the application at issue from the target location.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

The term “location” generally refers to a location within a network environment.

If the specification states a component or feature “may”, “can”, “could”, or “might” be included or have a characteristic, that particular component or feature is not required to be included or have the characteristic.

The phrase “path profile” generally refers to one or more network path parameters collectively or individually. One or more network path parameters may be measured, collected and/or estimated based on application exchange between the control location and the target location and/or the test location and the target location. Alternatively or additionally, network parameters may be measured, collected and/or estimated based on other traffic generated from the control location to the target location and/or the test location. Examples of network path parameters include, but are not limited to, round-trip time (RTT), maximum transmission unit (MTU), packet loss rate, throughput, bandwidth and latency for the control-target network path and/or the test-target network path.

The term “responsive” includes completely or partially responsive.

The phrase “target location” generally refers to a location that is managed by or on behalf of a person or entity providing a network-based application. This entity or person may be the same or different person or entity than that performing the application exchange performance measurement/estimation process. In embodiments of the present invention, one or more performance metrics of the network-based application as would be experienced by a user of the network-based application at the test location are desired to be known, measured and/or estimated.

The phrase “target profile” generally refers to one or more response timing parameters of the target location collectively or individually. A non-limiting example of a response timing parameter is the amount of time it takes for the target location to act on received information, such as an “HTTP GET” request. Various other response timing parameters will be apparent to those of ordinary skill in the art and include, but are not limited to, for example, the time required to respond to SSL handshake messages.

The phrase “test location” generally refers to a location at which a measuring party or a subscriber of an application measurement/estimation service wants to know or estimate one or more application exchange performance metrics. Notably, the subscriber may be the same person or entity providing the application from the target location.

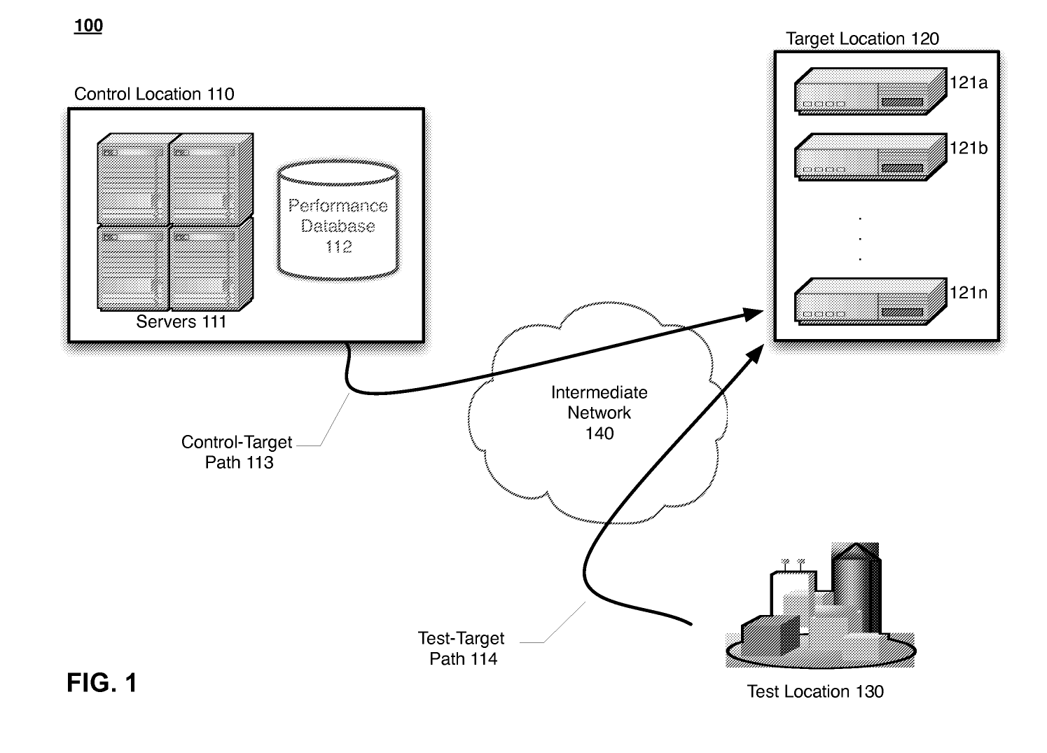

FIG. 1 is a block diagram conceptually illustrating a simplified network environment 100 in which embodiments of the present invention may be employed. In the present example, a control location 110, a target location 120 and a test location 130 are coupled in communication by way of an intermediate network 140, e.g., the Internet.

According to the present example, the control location 110 includes one or more server computer systems 111 and a performance database 112. In embodiments of the present invention, control location 110 generally represents a location that is managed by or on behalf of a person or entity driving an application exchange performance measurement/estimation process. The person or entity may be the same or different person or entity that is offering or otherwise making available the application at issue by way of target location 120.

In one embodiment, servers 111 are operable to perform various network and performance data measurement/estimation processes and may capture and retain the results of same in performance database 112, for example, for further analysis. According to one embodiment, control location 110 may compile and store a complete, accurately timed packet-level log of the traffic of an application exchange measured between control location 110 and target location 120.

In some embodiments, it is assumed that control location 110 allows generating network traffic towards the target to measure additional network parameters not readily deducible from the application exchange between control location 110 and target location 120. These additional network parameters may include, but are not limited to, round-trip time (RTT), maximum transfer unit (MTU) and bandwidth estimation of the control-target network path.

According to one embodiment, after desired application exchange is completed and captured, the traffic log and additional network information (e.g., network parameter measurements/estimations associated with control-target path 113 and/or test-target path 114) are analyzed to estimate and time a response profile of target location 120 as described further below. In one embodiment, a result of interacting with target location 120 from control location 110 is to derive a target profile, including, for example, how long it takes for target location 120 to act on received information, such as an “HTTP GET” request.

According to the present example, target location 120 includes multiple web and/or application servers 121a-n operable to provide one or more network-based applications. Non-limiting examples of Internet- or network-based applications include mail servers, backup servers and Voice over IP (VoIP) servers.

In one embodiment, target location 120 generally represents a location that is managed by or on behalf of a person or entity providing the one or more network-based applications of which one or more performance metrics are desired to be measured and/or estimated as would be experienced by a user at test location 130 interacting with the application(s). The person or entity providing the network-based application(s) may be the same or different person or entity than that performing the application exchange performance measurement/estimation process. As described further below, in one embodiment, control location 110 may also include a simulated target system (not shown) that may be configured, for example, to replay responses of an application provided by target location 120 captured by control location during a previous application test run by control location 110.

According to the present example, test location 130 generally represents a location at which a measuring party wants to know or estimate one or more application exchange performance metrics. According to one embodiment, control location 110 interacts with test location 130 to build a test-target path profile. Embodiments of the present invention assume only a limited variety of network tests can be performed at test location 130; however, rely upon an ability to measure at least the round-trip time (RTT) of test-target path 114. An ability to run tests that measure MTU for test-target path 114 and estimate bandwidth for test-target path 114 is also expected, but are optional.

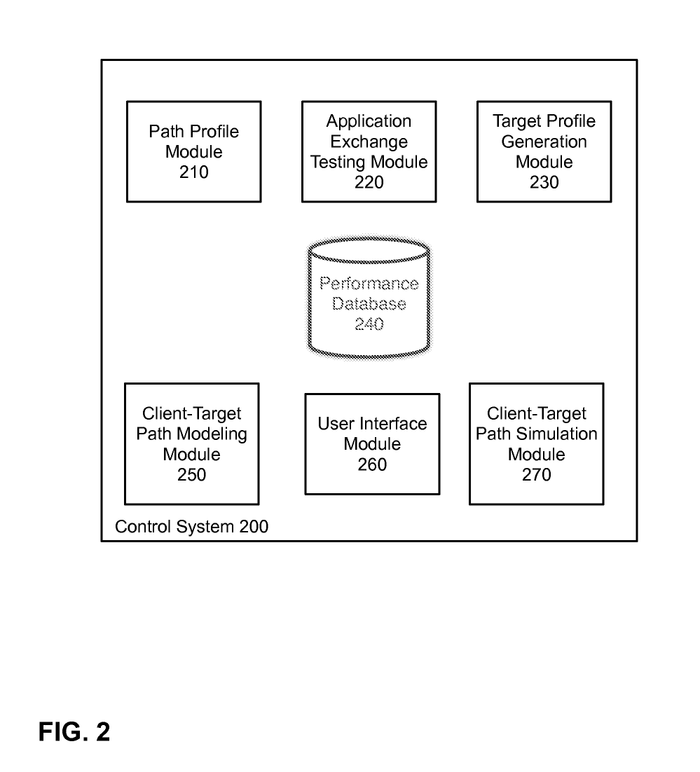

FIG. 2 is a block diagram conceptually illustrating interaction among various functional units of a control system 200 in accordance with an embodiment of the present invention. According to the present example, control system 200 includes a path profile module 210, an application exchange testing module 220, a target profile generation module 230, a performance database 240, a client-target path modeling module 250, a user interface module 260 and a client-target path simulation module 270.

The path profile module 210 is responsible for performing or causing to be performed one or more network tests for the purpose of ascertaining network path conditions for a particular network path at issue, e.g., control-target path 113 and/or test-target path 114.

Application exchange testing module 220 is responsible for performing or causing to be performed one or more application tests by interacting with an Internet- or network-based application provided by a target location. In one embodiment, the application exchange testing module 220 observes and otherwise measures the application exchange between the control location and the target location to build a parameterized model of the application exchange. In another embodiment, results from the application exchange testing module 220 are used to configure a simulated target system as described further below.

Target profile generation module 230 is responsible for determining a target profile based on the results of the one or more application tests performed by application exchange testing module 220 and based on the control-target path profile determined by path profile module 210.

Performance database 240 may store intermediate results, path profile information and/or estimated performance metrics. In one embodiment, performance database 240 represents a database management system; however, in alternative embodiments, performance database 240 may be a simple data store, such as a file.

Client-target path modeling module 250 is responsible for constructing and/or evaluating a parameterized model which expresses the performance of the application at issue as a variable of the network path profile(s) at issue.

User interface module 260 may provide an interface through with various of the application tests, network tests, modeling and/or simulation may be configured, initiated and/or monitored by an end user or developer associated with the testing location.

Client-target path simulation module 270 is responsible for configuring a simulated target system (not shown) based on the target profile and/or the derived test-target path conditions.

In one embodiment, the functionality of one or more of the above-referenced functional units may be merged in various combinations. For example, the client-target path modeling module 250 may be incorporated within the client-target path simulation module 270. Alternatively, control system 200 may support either modeling or simulation, but not both. As such, in some implementations only one of the client-target path modeling module 250 and the client-target path simulation module 270 may exist. Moreover, the functional units can be communicatively coupled using any suitable communication method (e.g., message passing, parameter passing, and/or signals through one or more communication paths etc.). Additionally, the functional units can be physically connected according to any suitable interconnection architecture (e.g., fully connected, hypercube, etc.).

According to embodiments of the invention, the functional units can be any suitable type of logic (e.g., digital logic) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). Examples of non-transitory machine-readable media include, but are not limited to, read only memory (ROM), random access memory (RAM), magnetic disk storage media, optical storage media and flash memory devices.

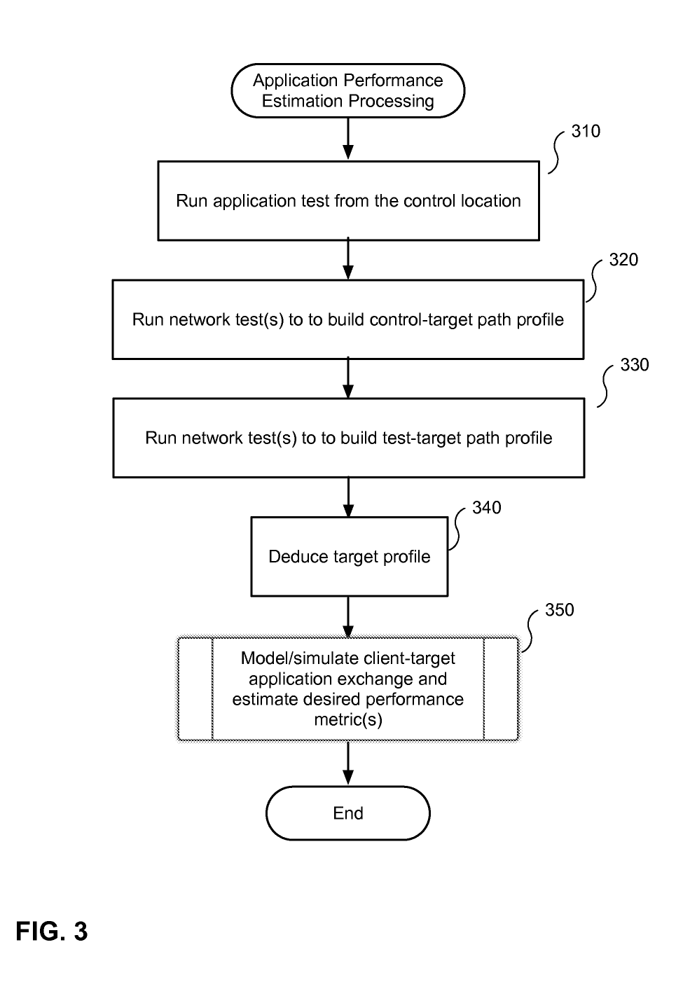

FIG. 3 is a high-level flow diagram illustrating application performance estimation processing in accordance with an embodiment of the present invention. Depending upon the particular implementation, the various process and decision blocks described herein may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

At block 310, an application test is run from the control location. In one embodiment, the application test involves one or more computer systems (e.g., servers 111) at a control location (e.g., control location 110) interacting with the application in a manner consistent with interactions expected to take place at a test location (e.g., test location 130) for which performance metrics are desired.

As described in further detail below with reference to Example #1, in one embodiment, based on the application exchange observed during the application test, the control location then creates a parameterized model of the application exchange that can be evaluated for a desired path profile, such as a test-target path profile (e.g., the network path conditions of test-target path 114).

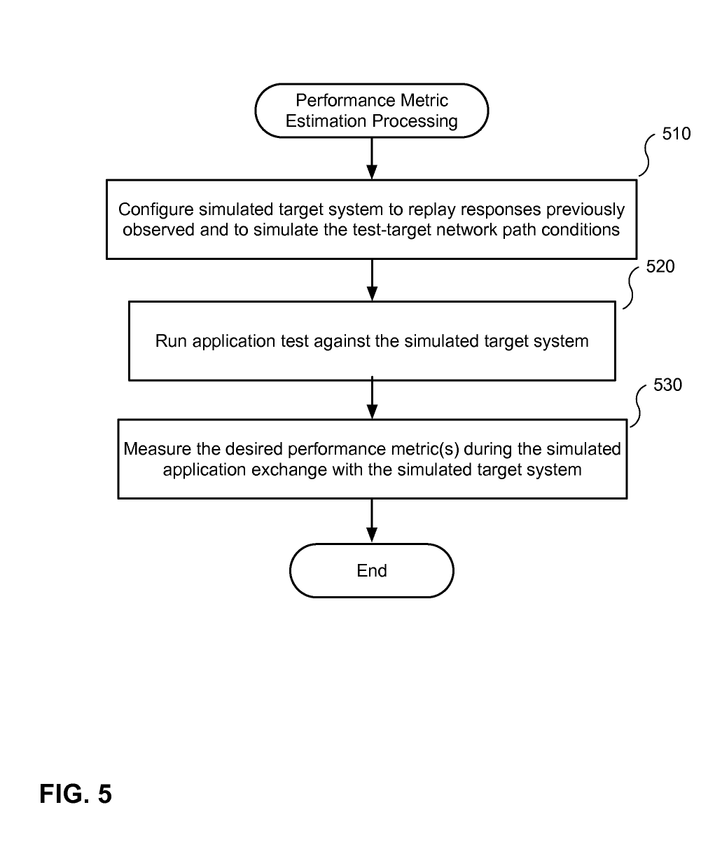

As described in further detail below with reference to FIG. 5 and Example #2, in one embodiment, a first application test can be initiated by the control location for the purpose of configuring a simulated target system to replay the responses from the target location during the application exchange of the first application test. Then, a second application test can be run by the control location against the configured simulated target system while simulating a desired path profile, such as a test-target path profile (e.g., the network path conditions of test-target path 114).

At block 320, one or more network tests are run to build a control-target path profile (e.g., the network path conditions of control-target path 113). According to one embodiment, an Internet Protocol (IP) ping utility may represent an example of a network test that may be used by the control location to measure one or more network path condition for the path connecting the control location and the target location. For example, the ping computer network utility may be used to measure RTT for messages sent from the target location to the control location and back or vice versa. The same utility can be used to measure the path MTU. In any event, based on the one or more network tests a control-target path profile is determined

At block 330, one or more network tests are run to build a test-target path profile (e.g., the network path conditions of test-target path 114). According to one embodiment, an Internet Protocol (IP) ping utility may represent an example of a network test that may be used by the user or target location (at the request of the control location or on its own initiative) to measure one or more network path condition for the path connecting the test location and the target location. For example, the ping computer network utility may be used to measure RTT for messages sent from the target location to the test location and back or vice versa. In any event, based on the one or more network tests a test-target path profile is determined.

At block 340, the target profile is deduced from the results of the one or more application tests performed during block 310 and from the control-target path profile determined during block 320. For example, once the speed of the application exchange is known between the control location and the target location and the RTT is known for the control-target path, other delays not attributable to DNS interaction can be attributed to response timing associated with the target location. DNS profiling at the test location is described further below.

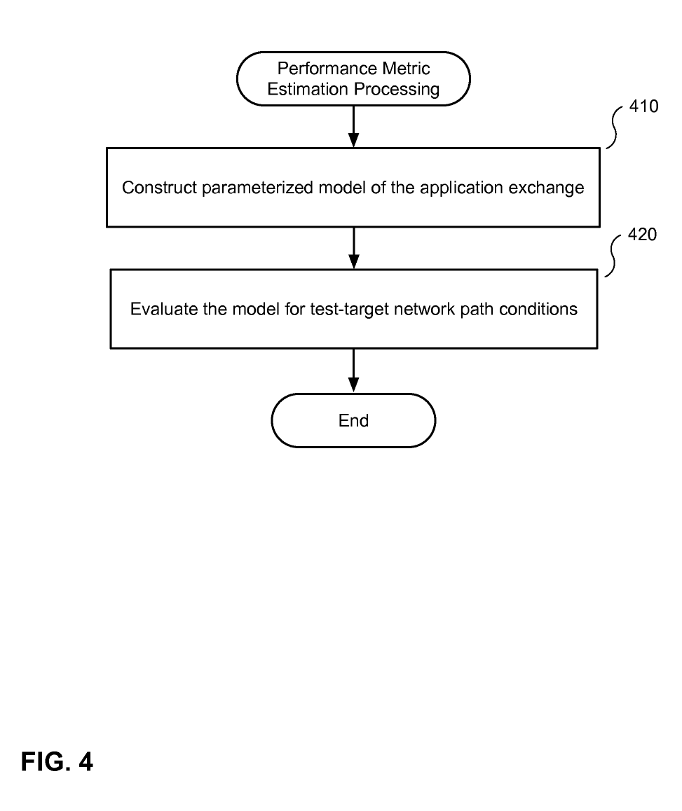

At block 350, modeling and/or simulation of the client-target application exchange are performed to estimate the desired performance metrics as described and illustrated further below with reference to FIGS. 4 and 5 and Example #1 and Example #2.

FIG. 4 is a flow diagram illustrating performance metric estimation processing in accordance with an embodiment of the present invention. According to the present example, FIG. 4 represents an example of modeling and model evaluation processing that may be performed in block 350 of FIG. 3.

At block 410, a parameterized model of the application exchange is constructed. In one embodiment, a parameterized model of the application exchange is constructed based on the target profile, as determined in block 340 of FIG. 3, for example, and the test-target path profile, as determined in block 330 of FIG. 3, for example. Creation of the model is an analytical approach and works, for example, by breaking down the observed application exchange into smaller parts and then expressing the performance of each part as a variable of the network path profile at issue. An example of a parameterized model is described below in the context of Example #1.

At block 420, the parameterized model is evaluated for test-target network path conditions. According to one embodiment, one or more network parameters measured in relation to the test-target path, as determined in block 330 of FIG. 3, for example, may be run through the model to produce one or more desired performance metrics for the test location. As such, in this example, the estimation works by plugging alternative network parameters into the resulting formula (or model) and calculating the desired performance metric(s). For purposes of illustration, a concrete example of this method is provided in Example #1 of the Example section below.

FIG. 5 is a flow diagram illustrating performance metric estimation processing in accordance with an alternative embodiment of the present invention. According to the present example, FIG. 4 represents an example of simulation processing that may be performed in block 350 of FIG. 3.

At block 510, a simulated target system is configured. According to one embodiment, the configuration accounts for both the previously derived test-target path conditions, as determined in block 330 of FIG. 3, for example, and the target profile, as determined in block 340 of FIG. 3, for example. An example configuration is described and illustrated below with reference to Example #2.

At block 520, a second application test is run by the control location, but this time against the configured simulated target system.

At block 530, the desired performance metric(s) are measured during the simulated application exchange between the control location and the configured simulated target system. As such, in accordance with the present example, the performance metric(s) desired is measured using the application itself. A concrete example of this method is provided in Example #2 in the Example section below.

It is to be noted that both performance metric estimation methods described herein have their limitations as some application exchanges may be difficult to model while others cannot be replayed. For rare cases when an application exchange can neither be modeled nor replayed, a variation of the simulation approach can be used in which the simulated target system replicates parts (or all) of the target location's logic and can adapt to dynamic changes introduced to the exchange by the application.

### Multiple Targets

It is not uncommon for a client in the application exchange to interact with more than one server in the context of a single application exchange. For example, loading a web page typically involves issuing a DNS query, requesting the actual page and all its dependencies (such as images hosted on cloud storage servers, third-party widgets or visitor tracking JavaScript code, for example), some of which may reside on some other servers not within the target location.

The application performance estimation, modeling and simulation methods described herein naturally extend to such cases by simply building respective path and targeting profiles for each target involved.

In some cases, the exact set of targets may vary depending on the other side's network location (e.g., when targets are geographically load-balanced). This too is expressly contemplated and can be accommodated by embodiments of the present invention as long as the target set can accurately be predicted (which is frequently the case as geographical load-balancing services are typically DNS-based).

Furthermore, in a subset of such cases an access to the targets from an arbitrary network location may be restricted. Specifically, DNS interaction is frequently subject to such restrictions and the implications of this are discussed in the next section.

### Domain Name System (DNS) Profiling at the Test Location

DNS interaction is an integral part of many application exchanges. As such, DNS interaction is a source of some portion of these application exchange delays, and therefore is accounted for during the performance estimation process of various embodiments of the present invention.

It is not atypical for DNS servers to be inaccessible to an “outside” test location as a result of the DNS servers being located within the confines of a client's local network. Such arrangement may prevent an estimate of the performance of DNS interaction from being generated by any location other than the test location. For this reason, an ability to perform and time DNS queries at the test location is expected in accordance with embodiments of the present invention, but is not required.

### Performance Metrics

As mentioned earlier, performance of the application exchange does not necessarily mean the speed of the exchange. Rather, it is just one of many possible performance metrics. For example, profiling a media streaming application may focus on measuring sustained frame rate or encoding quality expected to be able to be provided between the test location and the target location.

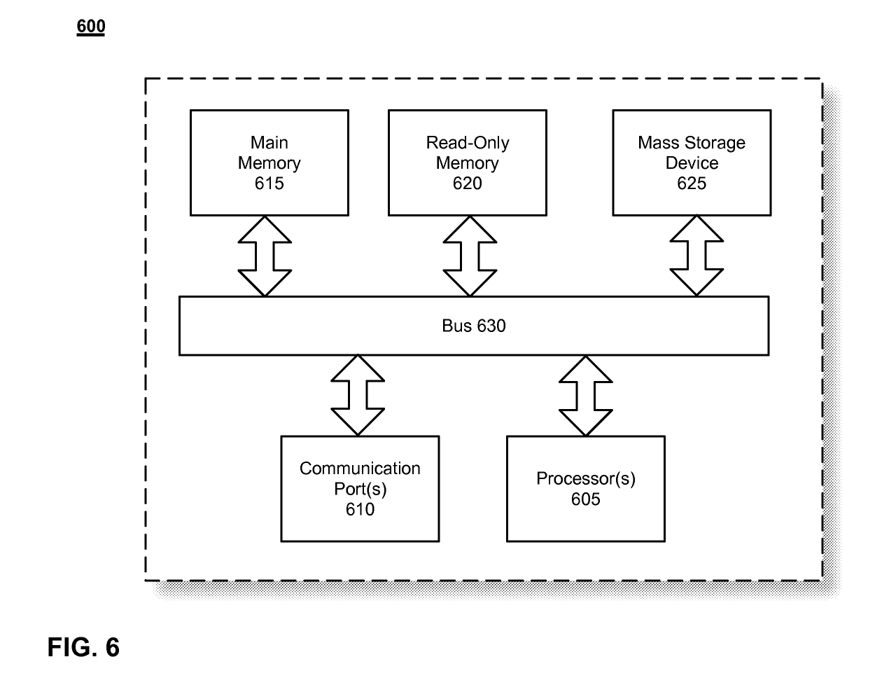

FIG. 6 is an example of a computer system with which embodiments of the present invention may be utilized. The computer system 300 may represent or form a part of one or more servers, client workstations and/or other computer systems residing at a control location (e.g., control location 110) and/or implementing one or more of path profile module 210, application exchange testing module 220, target profile generation module 230, performance database 240, client-target path modeling module 250, user interface module 260 and client-target path simulation module 270.

Embodiments of the present invention include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

According to FIG. 6, the computer system includes a bus 630, one or more processors 605, one or more communication ports 610, a main memory 615, a removable storage media 640, a read only memory 620 and a mass storage 625.

Processor(s) 605 can be any future or existing processor, including, but not limited to, an Intel® Itanium® or Itanium 2 processor(s), or AMD®, Opteron® or Athlon MP® processor(s), or Motorola® lines of processors. Communication port(s) 610 can be any of an RS-232 port for use with a modem based dialup connection, a 10/100 Ethernet port, a Gigabit port using copper or fiber or other existing or future ports. Communication port(s) 610 may be chosen depending on a network, such a Local Area Network (LAN), Wide Area Network (WAN), or any network to which the computer system 600 connects.

Main memory 615 can be Random Access Memory (RAM), or any other dynamic storage device(s) commonly known in the art. Read only memory 620 can be any static storage device(s) such as Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication ports 610.

Removable storage media 640 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the invention.

### EXAMPLES

As a result of the flexibility provided by various embodiments of the systems and methods described herein, it should be appreciated that it is not feasible to comprehensively describe all possible usage scenarios and application exchanges. Consequently, while various estimation examples are provided below in order to facilitate understanding of the flexible nature of the systems and methods contemplated herein, the examples should not be considered to be all-inclusive, limiting or static. Furthermore, the examples should not be considered mutually exclusive.

### Example #1

### Estimation Through Modeling

Consider the case of estimating the loading time of a web page. In this example, the page (.html) includes an external reference to a CSS stylesheet (.css) and a JavaScript file (.js). Furthermore, the .css references a sizable image file (.png).

The testing is performed with a version of the Firefox browser, and according to its operational logic, the sequence of HTTP requests it generates is as follows:

(a) get .html

(b) get .css and .js

(c) once js is received, get .png

Step 1—Application Performance Test

The browser is instructed to load and render the page, and also to ignore any cached copies of any page elements. The resulting HTTP exchanges are captured at the packet level, and they yield the flow illustrated by Table 1:

TABLE 1
Example Flow Data

| Time | | | |
|---|---|---|---|
| (ms) | Description | 1st connection | 2nd connection |
| 0 | Opening 1st connection | < TCP SYN | |
| 10 | | > TCP SYN/ACK | |
| | | < TCP ACK | |
| | Requesting .html | < HTTP GET .html | |
| 22 | Receiving .html | > HTTP (response) | |
| | Parsing .html | | |
| 43 | Requesting .css | < HTTP GET .css | |
| | Opening 2nd connection | | < TCP SYN |
| 53 | | | > TCP SYN/ACK |
| | | | < TCP ACK |
| | Requesting .js | | < HTTP GET .js |
| 55 | Receiving .css, 1/3 | > TCP chunk | |
| | Receiving .css, 2/3 | > TCP chunk | |
| 65 | Receiving .css, 3/3 | > HTTP (response) | |
| 221 | Receiving . js | | > HTTP |
| | | | (response) |
| | Processing .js | | |
| 231 | Requesting .png | < HTTP GET .png | |
| 242 | Receiving .png 1/20 | > TCP chunk | |
| | . . . 2/20 | > TCP chunk | |
| | | < ACK | |
| | . . . 3/20 | > TCP chunk | |
| 254 | . . . 4/20 | > TCP chunk | |
| | | < ACK | |
| | . . . 5/20 | > TCP chunk | |
| | . . . 6/20 | > TCP chunk | |
| | | < ACK | |
| 265 | . . . 7/20 | > TCP chunk | |
| | . . . 8/20 | > TCP chunk | |
| | | < ACK | |
| | . . . 9/20 | > TCP chunk | |
| | . . . 10/20 | > TCP chunk | |
| | | < ACK | |
| | . . . 11/20 | > TCP chunk | |
| | . . . 12/20 | > TCP chunk | |
| | | < ACK | |
| 276 | . . . 13/20 | > TCP chunk | |
| | . . . 14/20 | > TCP chunk | |
| | | < ACK | |
| | . . . 15/20 | > TCP chunk | |
| | . . . 16/20 | > TCP chunk | |
| | | < ACK | |
| | . . . 17/20 | > TCP chunk | |
| | . . . 18/20 | > TCP chunk | |
| | | < ACK | |
| | . . . 19/20 | > TCP chunk | |
| 277 | . . . 20/20 | > HTTP (response) | |

Where, “<” refers to a single packet sent from the client to the server, and “>” refers to a single packet sent in the opposite direction.

Flow analysis of the flow illustrated by Table 1 shows that:
(1) The round-trip time between the control and target locations is about 10 ms
(2) The server takes 2 ms to respond with .html (i.e., 22-10-RTT)
(3) The application takes 21 ms to parse .html
(4) The web server takes 158 ms to start sending .js (i.e., 221-53-RTT)
(5) The application takes 10 ms to digest .js
(6) It takes 4 cycles RTT milliseconds apart to transfer .png

From these observations the estimated page loading time works out to be:
RTT (1st connection)+2 ms (server preparing .html)+
RTT (.html request/response)+21 ms (browser digesting .html)+
RTT (2nd connection)+158 ms (server preparing .js)+
RTT (.js request/response)+10 ms (browser digesting .js)+
4*RTT (.png request/response)
which results in a parameterized model that can be expressed in simplified form as 191+8*RTT ms

### Step 2—Network Path Tests From The Control Location

This step would typically have been used to measure RTT, but in this case RTT is natively measured by TCP and so it is available from the flow captured in Step 1.

Step 3—Network Path Tests From The Test location

If pinging the web server from a test location shows the RTT of 93 ms, then the estimated page loading time from the same location is 935 ms (i.e., 191+8*93 ms).

### Further Discussion

The .png file used in the present example was around 25 KB and that precluded the TCP window of the 1st connection from reaching its full operational size. It also meant that no TCP congestion detection/avoidance mechanisms were triggered, and that in turn required no factoring of the available path bandwidth into the model. If the web page at issue would have referenced significantly larger files, the bandwidth restrictions would have influenced the loading speed and would have needed to be accommodated by the model.

### Example #2

### Estimation Through Simulation

Borrowing the above-illustrated application exchange example and derived target profile from the previous section, the simulation method differs in Step 3. Rather than plugging one or more values of parameters of the test-target path profile into a parameterized model of the application exchange, a simulated target system is configured to simulate a network connection consistent with the test-target network path conditions.

In the context of the present example, the simulated target system is set up by the control location and configured:

1. To expect and to accept connection requests

2. To expect and to receive HTTP GET request for .html and . . .

3. To respond with .html in 2 ms

4. To expect and to receive HTTP GET requests for .css and .js and . . .

5. To respond with .css right away and . . .

6. To respond with .js in 158 ms

7. To expect and to receive HTTP GET request for .png and . . .

8. To respond with .png

The simulated target system may be configured with a set of request-response rules that define what to respond with to which URI request, and how long of a pause to hold before responding. Other configuration arrangements are available as well. Next, the application and the simulated target system are connected by the means of simulated network connection, and this connection is configured to emulate 93 ms round-trip time (for example, by imposing 46.5 ms delay in each direction). Next, the application is made to load the page and the measured loading time is the estimation being sought.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A computer-implemented method comprising:
performing, by one or more computer systems at a control location, one or more tests involving an application exchange with an application provided by a target location not in proximity to the control location;
determining a control-target path profile by performing a first set of one or more network tests over a network path between the control location and the target location;
determining a test-target path profile by performing a second set of one or more network tests;
generating a target profile based on results of the one or more tests involving the application exchange with the application and the control-target path profile; and
providing an estimate of one or more performance metrics of an application exchange with the application between a test location and the target location based on the test-target path profile and the target profile.

2. The method of claim 1, wherein said performing a first set of one or more network tests comprises pinging a server residing at the target location from the control location.

3. The method of claim 1, wherein said performing a second set of one or more network tests comprises causing a server residing at the target location to be pinged from the test location.

4. The method of claim 3, wherein said performing a second set of one or more network tests further comprises causing Domain Name System (DNS) queries to be performed by the test location and measuring times associated with completing the DNS queries.

5. The method of claim 1, wherein the control-target path profile comprises information regarding a round-trip time (RTT) for a message to be sent from the control location to the target location and a response to the message to be received by the control location.

6. The method of claim 1, wherein the test-target path profile comprises information regarding a round-trip time (RTT) for a message to be sent from the test location to the target location and a response to the message to be received by the test location.

7. The method of claim 1, wherein the target profile comprises information regarding an amount of time it takes for the target location to advance the application session between phases of the application exchange.

8. The method of claim 1, wherein the application comprises a web server and a browser.

9. The method of claim 8, wherein the one or more performance metrics include a metric regarding estimated loading time of a web page from the web server.

10. The method of claim 1, wherein the application comprises a media streaming application.

11. The method of claim 10, wherein the one or more performance metrics include a metric regarding sustained frame rate.

12. The method of claim 10, wherein the one or more performance metrics include a metric regarding encoding quality.

13. The method of claim 10, wherein the one or more performance metrics include a metric regarding a speed of the application exchange.

14. The method of claim 1, wherein said providing an estimate of one or more performance metrics of the application exchange comprises:
formulating a model of the application exchange; and
evaluating the model based on information regarding the test-target path profile.

15. The method of claim 1, wherein said providing an estimate of one or more performance metrics of the application exchange comprises:
capturing, by the one or more computer systems, responses of the application;
configuring a simulated target system residing at the control location or on a sufficiently fast network connection to the control location to replay the captured responses and to simulate a network connection consistent with the test-target path profile; and
measuring the one or more performance metrics while performing, by the one or more computer systems residing at the control location, the one or more tests against the configured simulated target system.

16. The method of claim 1, wherein the application exchange involves interactions with more than one target at different locations, the method further comprising:
determining a second control-target path profile by performing a third set of one or more network tests over the network path between the control location and the second target location;
determining second test-target path profile by performing a fourth set of one or more network tests;
generating a second target profile based on the results of the one or more tests involving the application exchange with the application and the second control-target path profile; and
estimating the one or more performance metrics based on the test-target path profile, the second test-target profile, the target profile and the second target profile.

17. A non-transitory computer-readable storage medium tangibly embodying a set of instructions executable by one or more processors of one or more computer systems at a control location to perform a method for estimating application performance metrics, the method comprising:
performing one or more tests involving an application exchange with an application provided by a target location not in proximity to the control location;
determining a control-target path profile by performing a first set of one or more network tests over a network path between the control location and the target location;
determining a test-target path profile by performing a second set of one or more network tests;
generating a target profile based on results of the one or more tests involving the application exchange with the application and the control-target path profile; and
providing an estimate of one or more performance metrics of an application exchange with the application between a test location and the target location based on the test-target path profile and the target profile.

18. The computer-readable storage medium of claim 17, wherein said performing a first set of one or more network tests comprises pinging a server residing at the target location from the control location.

19. The computer-readable storage medium of claim 17, wherein said performing a second set of one or more network tests comprises causing a server residing at the target location to be pinged from the test location.

20. The computer-readable storage medium of claim 19, wherein said performing a second set of one or more network tests further comprises causing Domain Name System (DNS) queries to be performed by the test location and measuring times associated with completing the DNS queries.

21. The computer-readable storage medium of claim 17, wherein the control-target path profile comprises information regarding a round-trip time (RTT) for a message to be sent from the control location to the target location and a response to the message to be received by the control location.

22. The computer-readable storage medium of claim 17, wherein the test-target path profile comprises information regarding a round-trip time (RTT) for a message to be sent from the test location to the target location and a response to the message to be received by the test location.

23. The computer-readable storage medium of claim 17, wherein the target profile comprises information regarding an amount of time it takes for the target location to advance the application session between phases of the application exchange.

24. The computer-readable storage medium of claim 17, wherein the application comprises a web server and a browser.

25. The computer-readable storage medium of claim 24, wherein the one or more performance metrics include a metric regarding estimated loading time of a web page from the web server.

26. The computer-readable storage medium of claim 17, wherein the application comprises a media streaming application.

27. The computer-readable storage medium of claim 26, wherein the one or more performance metrics include a metric regarding sustained frame rate.

28. The computer-readable storage medium of claim 26, wherein the one or more performance metrics include a metric regarding encoding quality.

29. The computer-readable storage medium of claim 26, wherein the one or more performance metrics include a metric regarding a speed of the application exchange.

30. The computer-readable storage medium of claim 17, wherein said providing an estimate of one or more performance metrics of the application exchange comprises:
formulating a model of the application exchange; and
evaluating the model based on information regarding the test-target path profile.

31. The computer-readable storage medium of claim 17, wherein said providing an estimate of one or more performance metrics of the application exchange comprises:
capturing, by the one or more computer systems, responses of the application;
configuring a simulated target system residing at the control location or on a sufficiently fast network connection to the control location to replay the captured responses and to simulate a network connection consistent with the test-target path profile; and
measuring the one or more performance metrics while performing, by the one or more computer systems residing at the control location, the one or more tests against the configured simulated target system.

32. The computer-readable storage medium of claim 17, wherein the application exchange involves interactions with more than one target at different locations, the method further comprising:
determining a second control-target path profile by performing a third set of one or more network tests over the network path between the control location and the second target location;
determining a second test-target path profile by performing a fourth set of one or more network tests;
generating a second target profile based on the results of the one or more tests involving the application exchange with the application and the second control-target path profile; and
estimating the one or more performance metrics based on the test-target path profile, the second test-target profile, the target profile and the second target profile.
